(19) United States
(12) Patent Application Publication
(10) Pub. No.: US 2013/0023448 A1
(43) Pub. Date: Jan. 24, 2013

(54) Methods for Treating Hydrocarbon-Servicing Fluids and Wastewater and Fluids Produced Using the Same

(71) Applicants: Frederick J. Glasscott, West Chester, PA (US); Wayne F. Downey, JR., Millsboro, DE (US); Steven M. Fisher, Wilmington, DE (US); Mark J. McCasland, Kansas City, MO (US); Dan R. Neal, Duncan, OK (US)

(72) Inventors: Frederick J. Glasscott, West Chester, PA (US); Wayne F. Downey, JR., Millsboro, DE (US); Steven M. Fisher, Wilmington, DE (US); Mark J. McCasland, Kansas City, MO (US); Dan R. Neal, Duncan, OK (US)

(73) Assignee: A3ENVIRON TECHNOLOGIES LLC, Duncan, OK (US)

(21) Appl. No.: 13/185,465

(22) Filed: Jul. 18, 2011

(51) Int. Cl. C02F 9/12; C09K 8/52; C09K 8/02; E21B 43/26; C02F 11/06; C02F 1/32; C02F 1/72; E21B 43/16; C09K 8/62

(52) U.S. Cl. 507/100; 166/305.1; 507/200; 210/748.07; 210/718; 166/308.1

(57) ABSTRACT

A method for treating hydrocarbon-servicing fluid is provided for reducing contaminants, especially bacteria, volatile and semi-volatile organics, in hydrocarbon-servicing fluids by microwaving and irradiating the fluid with ultraviolet light, with or without use of catalyst. The treated fluid can be used in upstream and downstream hydrocarbon processing operations.

### CROSS-REFERENCE TO RELATED APPLICATIONS

### BACKGROUND OF THE DISCLOSURE

1. Field of the Disclosure

The disclosure relates generally to methods and apparatus for treating wastewater. In one aspect, this disclosure relates to treatment of hydrocarbon-servicing fluids used in upstream and downstream operations for energy production.

2. Background

Energy industry operations are generally characterized as upstream and downstream operations. Upstream operations focus on finding the hydrocarbons, drilling the formations, completing the wells and producing the hydrocarbons. Downstream operations focus on processing the hydrocarbon streams into petroleum products and petrochemicals in facilities such as refineries, gas plants and chemical plants.

Upstream operations such as hydraulic fracturing, acidizing, cleaning and other well service operations require large quantities of water. Water used in these operations may be treated with chemicals such as surfactants, scale inhibitors, fluid loss agents, friction reducing chemicals and the like. Water used in hydraulic fracturing operations may comprise gelling agents, proppants, biocides and the like.

In hydraulic fracturing operations, after injecting the frac fluids, large amounts of the fluid may be returned to the surface. This returned fluid is generally known as flowback water. Flowback water may contain contaminates such as volatile and semi-volatile hydrocarbons, soluble oil, emulsified oil, diesel, residual biocides and bacteria. Bacteria within the fluids may feed on organic polymers, such as those found in gelling agents. Growing sulfate-reducing bacteria (SRB) and acid-producing bacteria (APB) populations may produce hydrogen sulfide and iron sulfide that may produce scale, clog well screens and foul or sour the well.

Flowback water may be disposed or recycled. When flowback water is disposed, it is typically transported offsite and pumped downhole into disposal wells. When flowback water is recycled, it is typically first treated then blended with freshwater for a subsequent hydraulic fracturing operation. The most common treatment option for recycling flowback is to use distillation technology to distill flowback into substantially pure water and a concentrated waste stream. This waste stream may be hazardous due to concentration. The second main option is to remove suspended solids then blend with freshwater. Unfortunately, the process does not remove volatile and semi-volatile hydrocarbons. Hazardous biocides are frequently used to control growth of anaerobic bacteria, such as SRB and APB. These bacteria can create highly protected sites, either biostatic or spore states, which can facilitate reemerging populations. It is desirable to have methods and apparatus to reduce bacteria populations in waste streams such as recycled flowback water with reduced use of biocides or without biocides.

Downstream facilities processing hydrocarbons such as refineries, gas plants and chemical plants also require large quantities of water, predominantly for cooling water and steam generation. Waste streams from upstream and downstream operation may be discharged into bodies of water such as rivers, lakes and oceans. Such discharged waste streams may be harmful to the receiving bodies of water. The harm may be direct, wherein a particular pollutant adversely affects a species or it may be indirect. Adverse indirect affects may be increased oxygen demand or nutrient levels. Alternatively, the waste streams may be injected into deepwater wells, potentially exposing drinking water aquifers to pollutants. Thus, there is growing environmental concern regarding the amount and quality of wastewater being disposed into the environment.

Sludge from pits and tanks presents both solids waste disposal and wastewater disposal issues. The sludge may contain water that is contaminated with volatile and semi-volatile organic compounds, soluble oil, emulsified oil, diesel range oils and bacteria, including SRB's and other sulfur bearing contaminates. The sludge is usually dewatered before treating the resultant oily waste stream. Typical oily wastewater treatments may use biocides and other toxic chemicals.

It would be beneficial to have new methods and apparatus, which reduce the burden energy production and hydrocarbon processing places on the environment. Use of treatment processes such as those disclosed herein can provide many benefits including destruction of hazardous materials within the wastewater into non-hazardous materials, safer transport or disposal of treated wastewater, reduced demand on water resources by recycling treated wastewater, reduced use of surfactants, hazardous materials, like biocides, and reduced risk of groundwater contamination.

### SUMMARY OF THE DISCLOSURE

The present disclosure, in one aspect, provides a fluid that can be used as a hydrocarbon-servicing fluid by exposing fluid to microwaves and ultraviolet light. Fluids that can be treated according to this disclosure include untreated fresh or salt water, transported water, produced water, geothermal produced fluid, flowback water, cooling water, boiler water and stored water, which can include storm water runoff, wastewater from sludge pits, basins and tank bottoms and hydrocarbon-servicing fluids themselves. The fluid produced by the inventive process can be stored, recycled, reused or disposed.

In one particular aspect, hydrocarbon-servicing fluids used in upstream operations can be drilling fluid, acidizing fluid, cleaning fluid, produced fluid, injection fluid, formation fluid, flowback water, frac fluid, leak test fluid, packing fluid, rigwash, geothermal produced fluids and the like.

Hydrocarbon-servicing fluids used in downstream operations, in another aspect, can be cleaning fluids, desalter water, boiler water, cooling water and water used as solvents, diluents and the like.

In a broad aspect, waste streams can be hydrocarbon-servicing fluids, e.g., used or leftover drilling fluids, acidizing fluids, cleaning fluid, produced fluid, injection fluid, formation fluid, flowback water, frac fluid, leak test fluid, packing fluid, frac fluid, rigwash, cleaning fluids, desalter water, boiler water blowdown, cooling water, cooling tower water or cooling tower blowdown, and aqueous solvents and diluents. Other waste streams can be pit sludge, tank sludge, storm water runoff, and downstream operation wastewater treatment effluent and the like.

One embodiment of this disclosure provides a method for treating a hydrocarbon-servicing fluid comprising microwaving the hydrocarbon-servicing fluid and irradiating the hydrocarbon-servicing fluid with ultraviolet light to produce a treated stream for use in upstream or downstream operations. This method can be used to control bacteria in a hydrocarbon-servicing fluid, for example, flowback water, before pumping at least a portion of the treated stream to the wellbore. In a different aspect, the treated stream can be used to fracture a formation. A portion of the treated stream can be recycled into a wellbore or otherwise reused before or after storing the treated stream. Another aspect of this disclosure can be used to control bacteria in cooling water and boiler water. The treated stream can be conditioned before recycling or can be used with additives, useful in hydrocarbon-servicing fluids; such as surfactants, oxygen scavengers, scale inhibitors, fluid loss agents, friction reducing chemicals, gelling agents, proppants, biocides and the like.

In other aspects, the present disclosure provides a method for treating waste streams such as hydrocarbon-servicing fluids, pit sludge, storage tank sludge, storage basin fluids, storm water runoff, flowback water, contaminated hydraulic fluids, boiler water blowdown, cooling water, cooling tower blowdown, effluents from wastewater treatment facilities, oil refinery separation process, desalter water, hydrogen sulfide abatement waste, coker drilling water and the like.

In another embodiment, the present disclosure provides a process for treating a waste stream comprising mixing an iron catalyst stream with the hydrocarbon-servicing fluid, producing a first catalyzed stream; microwaving the first catalyzed stream, producing a microwaved stream. The microwaved stream can be recycled or stored as a treated stream. The waste stream provided can be a hydrocarbon-servicing fluid used in upstream operations or downstream operations.

One aspect of this disclosure can comprise exposing the first catalyzed stream to microwaves for substantially at least 0.3 seconds. The first catalyzed stream can be exposed to microwaves having a frequency of about 2.4 GHz to about 5.8 GHz. In another aspect, the waste stream can be heated before adding the iron catalyst to substantially at least 120° F.; or preferably, the waste stream can be heated from about 120° F. to about 140° F. Preferably, the heating fluid supply captures waste heat from on-site operations. In one aspect, the iron catalyst can comprise zero-valent iron or iron salts.

In another aspect, when the iron catalyst may comprise zero-valent iron, the disclosed method can further comprise the step of separating a substantial portion, or preferably, substantially all of the zero-valent iron from the microwaved stream producing an iron deficient stream and a zero-valent iron stream. Zero-valent iron removed from the microwaved stream can be disposed or stored for reuse. The iron depleted stream can then be treated further as described in this disclosure.

Any of the methods disclosed herein can optionally use steps to pretreat the waste stream or hydrocarbon-servicing fluid. Pretreatment steps can use API separators or coalescing separators for removing oil, oily water and solids. Pretreatment can be used to separate the waste stream into an oily water stream, a large solids stream and a pretreated stream. The resulting pretreated stream can have fine solids removed, a fine solids stream and optionally producing a solids deficient stream. The fine solids can be removed by a diatomaceous earth filter, centrifuge or a series of screens and filters. Fine solids removed can be substantially at least 30, preferably 20 or more preferably 10 microns or larger. Solids removed from the waste stream or pretreated stream can be disposed with the filter or stored in a solids tank for separate treatment or disposal.

In another aspect, the disclosed embodiment can also comprise the steps of mixing an iron catalyst stream with the solids deficient stream, producing a first catalyzed stream, microwaving the first catalyzed stream, producing a microwaved stream, which can be recycled or stored as a treated stream. In further aspect, this embodiment can comprise the step of irradiating the microwaved stream with ultraviolet light. This embodiment can further comprise spraying a hydrogen peroxide stream into the ultraviolet system. Hydroxyl radicals can be made by exposing the hydrogen peroxide to ultraviolet light. Preferably, a hydrogen peroxide stream from about 25 wt % to about 50 wt % can be irradiated using UVB and UVC wavelengths. In a preferred aspect, deep ultraviolet wavelengths can be used.

In a preferred aspect, hydroxyl radicals can be generated in-situ. In this embodiment, a nozzle can be used to spray the hydrogen peroxide stream within the ultraviolet system, simultaneously irradiating the hydrogen peroxide with ultraviolet light to produced hydroxyl radicals and irradiating the microwaved stream with ultraviolet light. In one aspect, a hydrogen peroxide spray can be created from a nozzle within the ultraviolet system such that a substantial portion of the hydrogen peroxide spray is near an ultraviolet source within the ultraviolet system. In another aspect, the hydrogen peroxide can be atomized. In a preferred aspect, a substantial portion of the spray can be less than 5 cm from an ultraviolet source, more preferably less than 1 cm. In other aspects, the nozzle can be located above, below or at the sides of the ultraviolet source. At least one nozzle can be preferably located above the ultraviolet source. Multiple nozzles, using various spray patterns, and multiple ultraviolet sources with varying configurations can be used within the ultraviolet system.

Hydroxyl radicals formed by the ultraviolet light can impinge the microwaved stream, oxidizing organic contaminants and breaking apart carbon-based molecular chains. In a preferred aspect of this embodiment, the microwaved stream may be channeled by a distributor into at least one sheet of fluid before exposing the at least one sheet of fluid to ultraviolet light. In another aspect, an iron salt stream, preferably iron sulfate, can be mixed with the microwaved stream before feeding the microwaved stream to the ultraviolet system. This embodiment can comprise the additional steps of irradiating the treated stream with ultraviolet light, aerating, degassing and partially removing salt. Another aspect of this embodiment can comprise heating the solids deficient stream to substantially at least 120° F. or more preferably, from about 120° F. to about 140° F.

In addition to treating upstream or downstream hydrocarbon-servicing fluids, a method of this disclosure can also treat pit sludge, tank sludge, storm water runoff, downstream operation wastewater treatment effluent, pharmaceutical wastewater and municipal wastewater. Another aspect of this method can comprise separating the waste stream into an oil rich stream, a large solids stream and a pretreated stream; removing solids substantially at least 10 microns from the pretreated stream, producing a fine solids stream and a solids deficient stream; mixing an iron catalyst stream with the solids deficient stream, producing a first catalyzed stream; microwaving the first catalyzed stream, producing a microwaved stream. Yet another aspect of the disclosed method can heat the solids deficient stream to substantially at least 120° F. before mixing the solids deficient stream with an iron catalyst.

In other aspects, the iron catalyst stream can comprise zero-valent iron. This embodiment can additionally comprise separating a substantial portion of the zero-valent iron or, more preferably, substantially all of the zero-valent iron from the microwaved stream, providing an iron depleted stream and a zero-valent iron stream. The zero-valent iron stream can be disposed, stored for reuse or recycled to the iron catalyst stream. The iron depleted stream can be fed to an ultraviolet system. Additionally, a hydrogen peroxide stream can be provided to the ultraviolet system for irradiation with ultraviolet light simultaneously with the iron depleted stream. Furthermore, the hydrogen peroxide stream and the iron depleted stream can be irradiated separately and simultaneously within the ultraviolet system, producing an irradiated stream. Another aspect of the disclosure also comprises the steps of aerating the irradiated stream, producing an aerated stream; and degassing the aerated stream, producing a treated stream. The aeration and degasification can be accomplished with a single device.

In accordance with another aspect of this disclosure, an iron catalyst, preferably iron sulfate, can be provided and mixed with the iron depleted stream, preferably, before the iron depleted stream and the hydrogen peroxide stream are irradiated with ultraviolet light. The disclosure, in another aspect, comprises aerating the irradiated stream, producing an aerated stream and degassing the aerated stream, producing a degassed stream. This disclosure, in yet another aspect, comprises removing a portion of salt from the degassed stream, producing a treated stream. The treated stream can be stored, recycled, reused or disposed. This embodiment can preferably be used to treat flowback water, production fluid, geothermal production fluid, drilling fluid, tank sludge or pit sludge. One aspect of this embodiment can comprise recycling the treated stream into a wellbore before or after storing.

Another disclosed method for treating a waste stream can comprise providing a waste stream to a fine solids removal system; removing solids being substantially at least 10 microns; producing a fine solids stream or capturing the fine solids within a filter and producing a solids deficient stream; disposing the fine solids stream to a solids storage tank (not shown); heating the solids deficient stream to substantially at least 120° F.; mixing an iron catalyst stream comprising zero-valent iron, with the solids deficient stream; producing a first catalyzed stream; microwaving the first catalyzed stream, producing a microwaved stream; separating a substantial portion of the zero-valent iron from the microwaved stream, producing an iron depleted stream and a zero-valent iron stream; mixing an iron salt stream, preferably comprising iron sulfate, with the iron depleted stream, producing a second catalyzed stream; channeling the second catalyzed stream in an ultraviolet system, producing at least one fluid sheet; providing hydrogen peroxide stream to the ultraviolet system; irradiating the hydrogen peroxide stream and at least one fluid sheet with ultraviolet light simultaneously, or optionally simultaneously and separately, producing an irradiated stream; oxygenating the irradiated stream, providing an aerated stream, off gas, and a precipitated solids stream; and filtering the aerated stream using a liquid membrane, producing a treated stream. In one aspect, the oxygenating step can utilize cascade aerators, witches' hats or spargers. Offgas produced by the oxygenating step can be treated with a gas membrane, producing an exhaust gas. Optionally, the aerated stream can be degassed using a degasifier. The precipitated solids stream can be treated using a liquid membrane, producing a stripped solids and salts stream and a treated stream.

The disclosed methods can incorporate recording or control of various control parameters like temperature, flow, pressure, pH, chemical oxygen demand (COD) and biological oxygen demand (BOD) or total organic carbon (TOC). In preferred aspects, the disclosed methods can include sampling, monitoring or recording a parameter wherein the parameter can be controlled manually or automatically. In other preferred aspects, the COD, BOD or TOC of the solids deficient stream or treated stream monitoring can use an on-line meter or controller for recycling a partially treated stream or the treated stream back to any of treatment steps of this disclosure.

Optional treatment steps can be used with the disclosed methods. These treatment steps can include additional exposure to microwaves; ultraviolet irradiation; flocculation; settling; filtration; oxidation, using oxidizing agents including hydrogen peroxide, ozone, air and iron catalysts; aeration; degasification; water softening and desalinization, all of which can be conducted in a series or parallel manner.

### NOTATION AND NOMENCLATURE

In the following discussion and in the claims, the terms “including” and “comprising” are used in an open-ended fashion, and thus should be interpreted to mean “including, but not limited to . . . ”.

Singular or plural number(s) may also include the plural or singular number respectively.

The word “or” in reference to a list of two or more items, that word covers all of the following interpretations of the word: any of the items in the list, all of the items in the list, and any combination of the items in the list.

The word “recycle” may include recycle to a treatment step or steps, recycle to the water source or water source operation or reuse in a different operation.

In the figures, dashed lines represent optional configurations, processing steps, systems or equipment.

Certain terms are used throughout the following description and claims to refer to particular system components. This document does not intend to distinguish between components that differ in name but not function. It should be understood that examples of the more important features of the disclosure have been summarized rather broadly in order that detailed description thereof that follows may be better understood, and in order that the contributions to the art may be appreciated. There may be additional features of the disclosure that will be described hereinafter and which will form the subject of the disclosure. The summary provided herein is not intended to limit the scope. Also, an “Abstract” is provided to satisfy certain patent office requirements and is not to be used in any way to limit the concepts, methods, compositions or embodiments disclosed herein or the scope of claims that may be made in this applications or any application that may take a priority from this application.

### BRIEF DESCRIPTION OF THE DRAWINGS

The advantages and further aspects of the disclosure will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is a block flow diagram of a broad embodiment of the disclosure for treating of hydrocarbon-servicing fluids using microwaves and ultraviolet irradiation.

FIG. 2 is a block flow diagram of an embodiment of the disclosure for treating hydrocarbon-servicing fluids using microwaves further illustrating heating and adding iron catalyst.

FIG. 3 is a block flow diagram of an embodiment of the disclosure for treating waste streams using microwaves further illustrating pretreatment and fine solids removal.

FIG. 4 is a block flow diagram of an embodiment of the disclosure for treating waste streams using microwaves and ultraviolet light further illustrating providing a second iron catalyst.

FIG. 5a is a block flow diagram of an embodiment of the disclosure for treating waste streams using microwaves and ultraviolet light illustrating the additional treatment steps of aeration and degasification.

FIG. 5b is a block flow diagram of an embodiment of the disclosure for treating waste streams using microwaves and ultraviolet light illustrating additional treatment step of salt removal.

FIG. 6 is a block flow diagram of an alternate embodiment of the disclosure for treating waste streams using microwaves and ultraviolet light illustrating several additional treatment steps including spargers, liquid membrane filtration and gas membrane filtration.

Dashed lines on the figures represent discretionary aspects of the disclosed invention.

### DETAILED DESCRIPTION OF THE PREFERRED EMBODIMENTS

This disclosure is related to methods and apparatus for treating waste fluids and hydrocarbon-servicing fluids. The drawings shown and the descriptions provided herein correspond to certain specific embodiments of the present disclosure for the purposes of explanation and are representative only. It is not intended to limit the scope of the disclosure to the illustrated drawings and the descriptions herein.

Referring now to the drawings in detail, various methods and apparatus for treating waste fluids and hydrocarbon-servicing fluids will be described wherein like elements are designated by like reference numerals. Specific embodiments for treating waste streams and hydrocarbon-servicing fluids to reduce bacteria populations and volatile and semi-volatile organic compounds are illustrated. As described above, hydrocarbon-servicing fluids can be used in upstream or downstream operations. Typical upstream operations include drilling and production of oil or gas. Typical downstream operations include hydrocarbon processing operations like refining, gas processing and petrochemical production. It is to be understood that the different teachings of the embodiments disclose herein can be used separately or in any suitable combination to produce desired results.

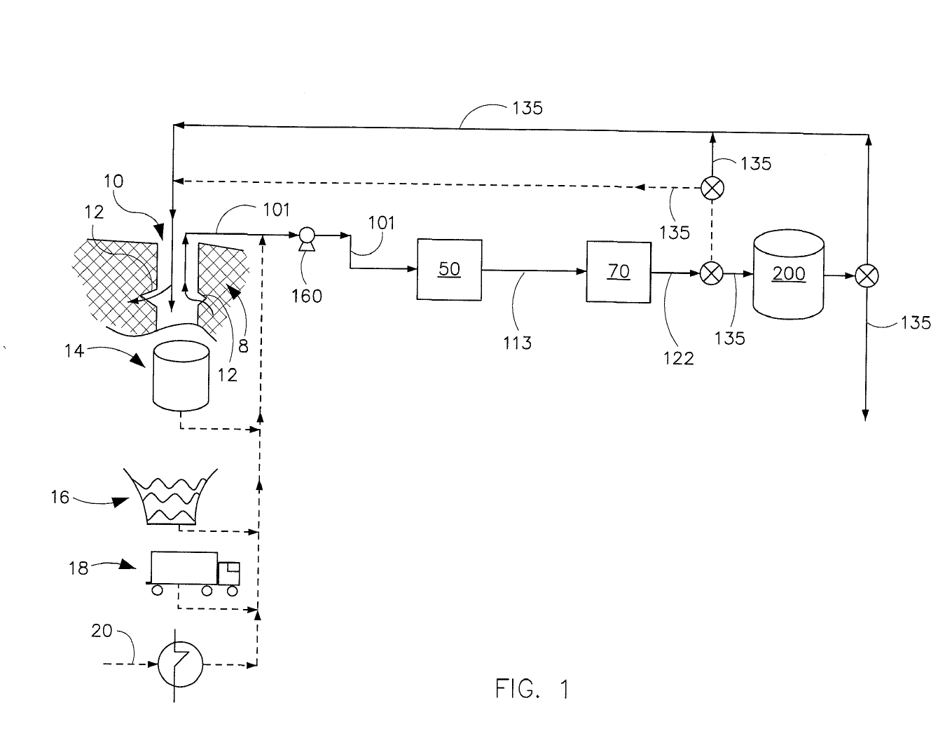

FIG. 1 schematically illustrates a method for treating waste fluid or hydrocarbon-servicing fluids to reduce bacteria populations, volatile and semi-volatile compounds, biocides and other organics. An upstream operation is illustrated by FIG. 1. A hydrocarbon-servicing fluid 101 from formation 8 can be lifted by pump 160 from a wellbore 10 to a microwave system 50. The microwave system 50 employs a magnetron capable of exposing the hydrocarbon-servicing fluid 101 through a microwave-transparent window to frequencies generally between 2.4 GHz to about 5.8 GHz. The microwaves have both thermal and non-thermal effects, which break organic compounds into smaller or soluble components and disrupt genetic material of microorganisms such as SRB and APB. The microwaved stream 113 can be passed to an ultraviolet system 70 and irradiated by ultraviolet light. Alternate water sources depicted on FIG. 1 like stored water 14, fresh water and salt-water sources 16, transported water 18, and downstream operation sources like cooling water 20 are not to be considered as limiting water sources or waste stream sources for treatment according to this disclosure.

The effectiveness of ultraviolet light on microorganisms is a function of the time of exposure and intensity of the light. The ultraviolet system 70 can comprises at least one ultraviolet source emitting 100 nm to 400 nm wavelengths, preferably from about 100 nm to about 300 nm, more preferably about 280 nm. Ultraviolet lamps, emitting lasers or light-emitting diodes can be used as ultraviolet light sources. The ultraviolet system 70 can comprise a monitoring system to measure the intensity of the ultraviolet flux. The ultraviolet system 70 can comprise a monitoring system to determine whether a particular source is on. The irradiated stream 122 can flow to treated wastewater tank 200 or preferably, the treated stream 135 can be recycled to the wellbore 10 through perforation(s) 12 for reuse. The treated stream 135 can be recycled before or after storage. The treated stream 135 can also be otherwise reused or transported for disposal.

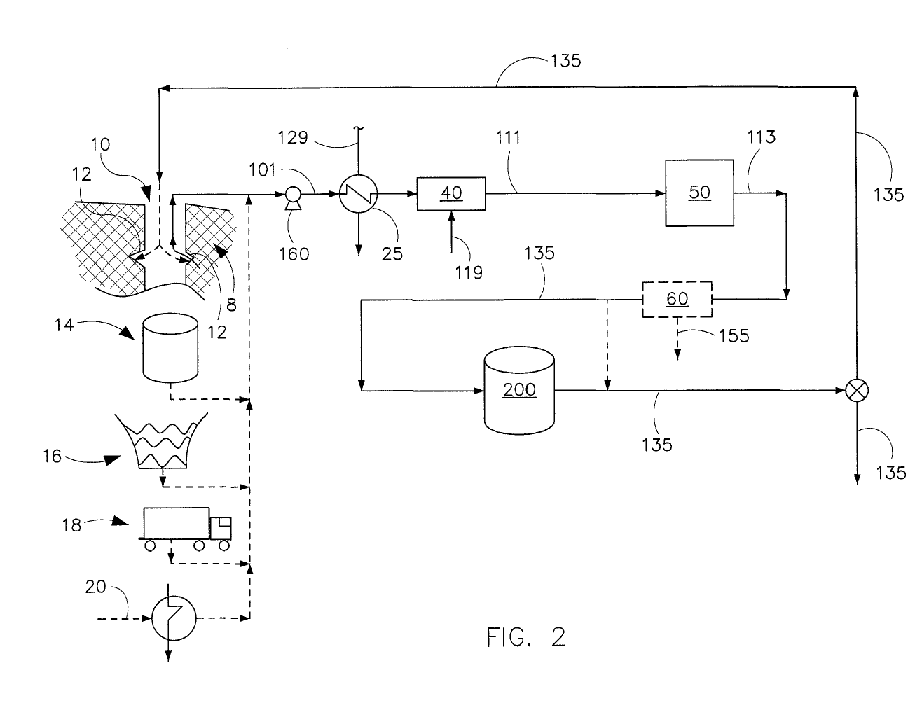

FIG. 2 illustrates another embodiment for treatment of hydrocarbon-servicing fluid 101 wherein the hydrocarbon-servicing fluid 101 can be pumped through a heat exchanger 25 to a first iron mixer 40 to be blended with an iron catalyst stream 119, producing a first catalyzed stream 111. The hydrocarbon-servicing fluid 101 can be preferably heated to substantially at least 120° F. before being mixed with the iron catalyst stream 119. Preferably, the heating fluid supply 129 can be a waste heat stream from on-site operations. The first iron mixer 40 can preferably be an inline static mixer, but other commercially available types of mixers can be used. The iron catalyst can comprise an iron salt, preferably iron sulfate, or zero-valent iron. The first catalyzed stream 111 can be microwaved in the microwave system 50. Microwave thermal effects break organics into smaller or soluble components.

When the iron catalyst stream 119 comprises zero-valent iron, the microwaved stream 113 can be fed to iron separator unit 60 to remove a substantial portion of the zero-valent iron or preferably substantially all the zero-valent iron. The iron separator unit 60 can use filtration or magnetic fields for separation. Zero-valent iron stream 155 can be disposed stored or reused. The treated stream 135 can be fed to treated wastewater tank 200. The treated stream 135 can also be optionally recycled for further treatment, before or after storage. The recycle flow can be controlled by a controller base upon chemical oxygen demand, biological oxygen demand or total organic carbon. The treated stream 135 can also be otherwise reused or disposed.

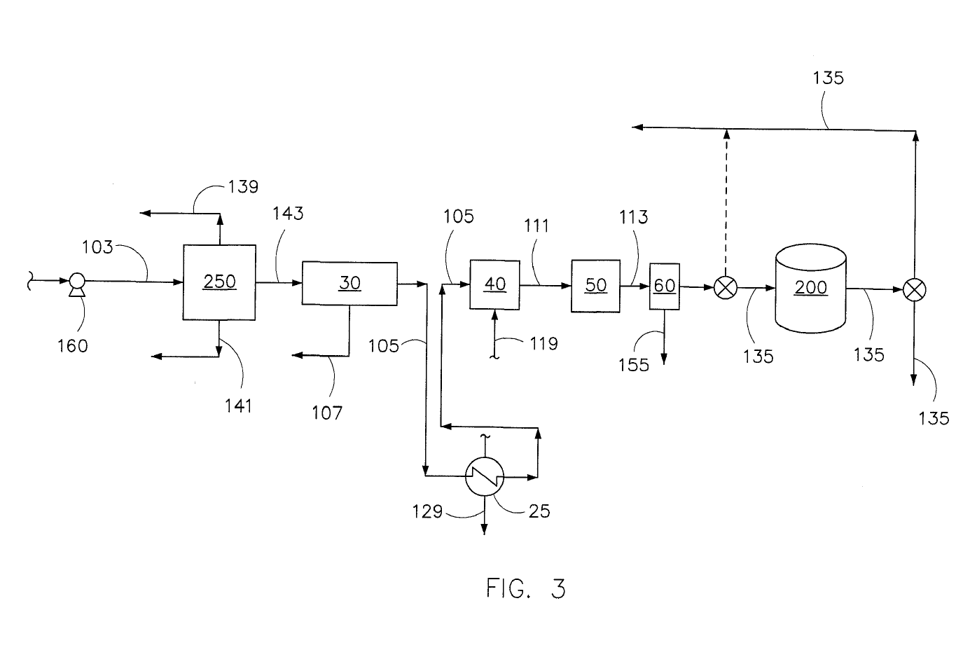

FIG. 3 illustrates a method for treating a waste stream. Waste stream 103 can be fed to separator 250, which divides the waste stream into a large solids stream 141, an oily water stream 139 and a pretreated stream 143. Optionally, the separation step can remove an oil steam (not shown) depending on separator configuration and the oil content of the waste stream. Separator 250 can be any separator capable of gross amounts of oil and suspended large solids from a waste stream, e.g. gravity separators, coalescing separators, centrifugal force separators and the like. The pretreated stream 143 can be fed to the fine solids removal system 30. The fines solids removal system 30 can use filters, e.g. bag filters, cartridge filters and the like or centrifugal force separators. When filters are to be used, a differential pressure transmitter can monitor the pressure drop across the filter and trigger an alarm to change the filter or regenerate.

The fine solids system 30 produces a fine solids stream 107 for disposal and a solids deficient stream 105. After exiting the fine solids system 30, the solids deficient stream 105 can be fed through a heat exchanger 25 to the first iron mixer 40 to be mixed with an iron catalyst stream 119 comprising zero-valent iron; producing a first catalyzed stream 111. Heat exchanger 25 can use heating fluid supply 129 for preheating solids deficient stream 105. The first catalyzed stream 111 can be fed to a microwave system 50 and microwaved. The microwaved stream 113 can be fed to an iron separator 60 to remove a substantial portion of the zero-valent iron, producing a zero-valent iron stream 155. Preferably, substantially all of the zero-valent iron can be removed by iron separator 60. The resultant treated stream 135 can be stored in a treated wastewater tank 200 or optionally recycled. The zero-valent iron stream 155 can be disposed or reused.

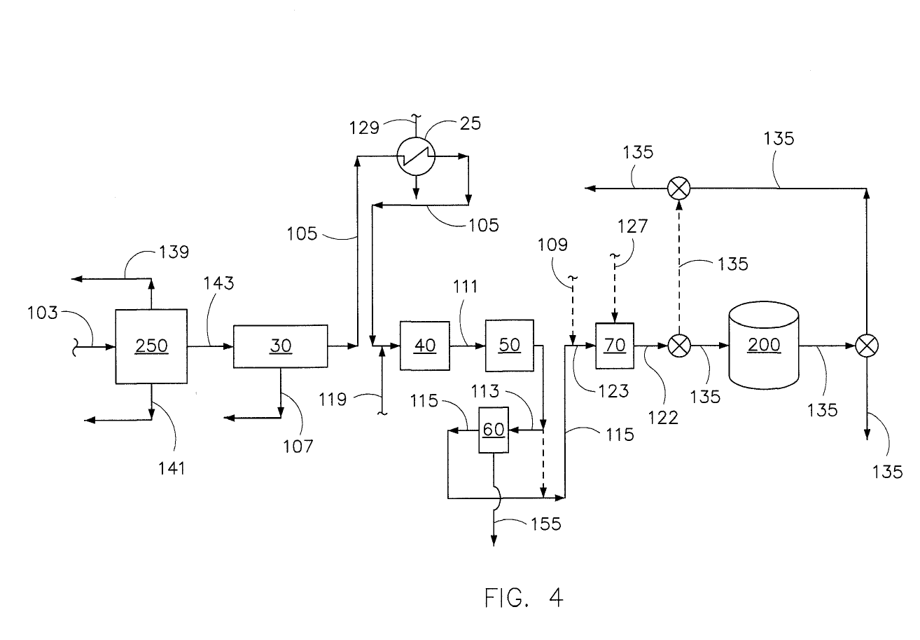

Referring to FIG. 4, a process for treating a waste steam 103 including uses of ultraviolet light is illustrated. Absorption of ultraviolet light by microorganisms is reduced if solids shield light from the target contaminants. Thus, preferred embodiments using ultraviolet light comprise solids removal steps like those illustrated in FIG. 3 wherein the waste stream 103 can be fed to separator 250, which separates an oily water stream 139 and a large solids stream 141 from waste stream 103, producing a pretreated stream 143. Pretreated stream 143 can be fed to a fine solids removal system 30 configured for different particle size removal. The fine solids removal system 30 can produce a fine solids stream 107 and a solids deficient stream 105. Filters capable of removing particles with various pore sizes can be used by the fine solids removal system and can be designed to remove particulates greater than 30, preferably greater than 20 microns, or more preferably greater than 10 microns. The solids deficient stream 105 can be fed through a heat exchanger 25 to first iron mixer 40. An iron catalyst stream 119 comprising zero-valent iron and the solids deficient stream 105 can be mixed in the first iron mixer 40, producing a first catalyzed stream 111. Heat exchanger 25 can use heating fluid supply 129 for preheating solids deficient stream 105. The first catalyzed stream 111 can be fed to the microwave system 50, producing microwaved stream 113. The microwaved stream 113 can be fed to an iron separator 60 to remove a substantial portion of the zero-valent iron from the microwaved stream 113, producing an iron depleted stream 115 and a zero-valent iron stream 155. The iron depleted stream 115 can be fed to an ultraviolet system 70. The zero-valent iron stream 155 can be disposed or reused. Optionally, wherein the iron catalyst stream 119 does not comprise zero-valent iron, the microwaved stream 113 can be fed directly to the ultraviolet system 70.

Iron salts and zero-valent iron are reducing agents. It is believed that reduction of organic contaminants before subsequent Fenton Reaction oxidation may augment organic destruction. It is also believed zero-valent iron will enhance thermal effects and will generate more Fe(II) ions for subsequent use as represented by the equation below.

Fe⁰+H₂O→Fe²⁺+2OH⁻+H₂

A preferred embodiment illustrated in FIG. 4 can comprise the additional step of infusing, injecting or atomizing oxidants within the ultraviolet system 70. Microorganisms within the iron depleted stream 115 can absorb ultraviolet light, disrupting their DNA and RNA thereby reducing their ability to reproduce. Oxidants also destruct organics and microorganisms. Ozone or hydrogen peroxide can be used as oxidizing agents in this embodiment. Hydrogen peroxide is preferable as it can be stored onsite rather than requiring onsite generation. The hydrogen peroxide stream 127 can be injected as a liquid, preferably sprayed or more preferably atomized into the ultraviolet system 70.

The hydrogen peroxide stream 127 can be preferably sprayed or atomized directly onto the iron depleted stream 115 within the ultraviolet system 70 while both streams can be simultaneously, but separately, irradiated with the ultraviolet light. Ultraviolet photolysis of hydrogen peroxide can form two free hydroxyl radicals as shown below.

H₂O₂+hv=2.OH

Hydroxyl radicals are potent oxidizers with a short life. By simultaneously, but separately, irradiating the hydrogen peroxide stream 127 and the iron depleted stream 115 with ultraviolet light, the exposure of the hydrogen peroxide to ultraviolet light can be less obscured by the iron depleted stream 115. Thus, it is believed, exposing the un-obscured hydrogen peroxide spray will result in a higher rate of hydroxyl radical production and a higher rate of oxidation of the organics in the iron depleted stream 115 as hydroxyl radicals can be formed within the spray and impinge the iron depleted stream 115 nearly instantaneously.

An optional aspect of the embodiment illustrated in FIG. 4 can comprise the step of mixing an iron salt stream 109 comprising Fe(II)SO₄ with the iron depleted stream 115, producing a second catalyzed stream 123, before being fed to the ultraviolet system 70. Mixing the iron salt stream 109 with iron depleted stream 115 can be accomplished by turbulence within a piping system or by using a mixer (not shown). Hydrogen peroxide not photolyzed into hydroxyl radicals in the spray can be catalyzed by iron salt producing more hydroxyl radicals within the iron depleted stream 1115 after the spray impinges the iron depleted stream 115. Generally known as Fenton's Reaction, Fe(II) has a special oxygen transfer property which improves the conversion of hydrogen peroxide into hydroxyl radicals as shown below:

Fe²⁺+H₂O₂→Fe³⁺+.OH+OH⁻

Preferably, the pH for this reaction can be controlled between 3 and 6 as iron may precipitate as Fe(OH)₃ if the pH becomes too high. Buffers can be added to aid with pH control. The irradiated stream 122 from the ultraviolet system 70 can flow to treated wastewater tank 200 as treated stream 135. Preferably, the treated stream 135 can be recycled. The treated stream 135 can be recycled before or after storage. The treated stream 135 can also be reused or disposed.

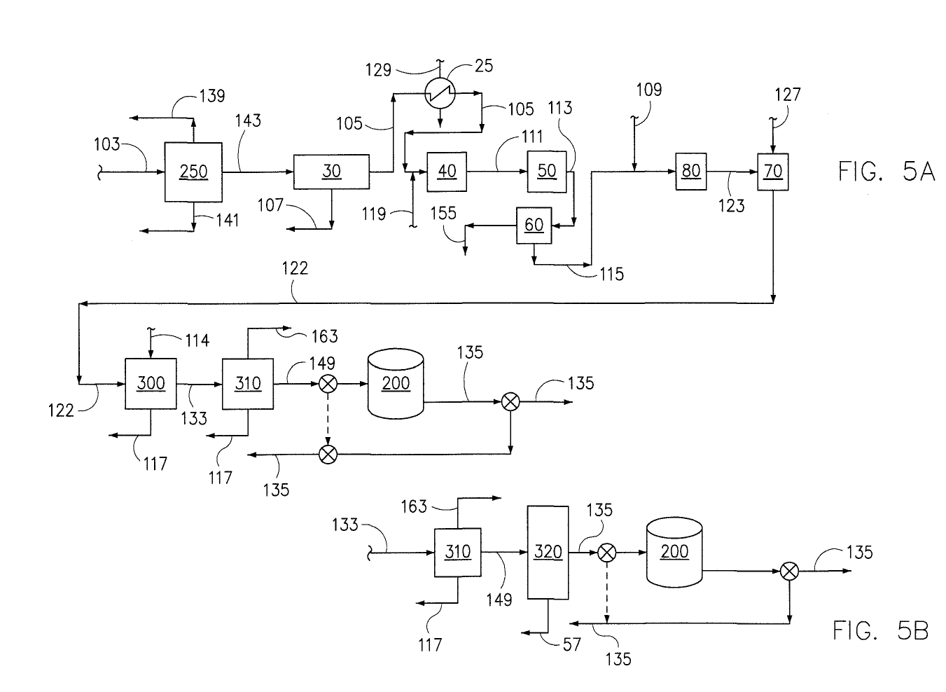

Turning to FIG. 5a, the waste stream 103 can be fed to separator 250 which separate an oily water stream 139 and a large solids stream 141 from waste stream 103, producing a pretreated stream 143. Pretreated stream 143 can be fed to a fine solids removal system 30 configured for different particle size removal, producing a fine solids stream 107 or capturing fine solids within a filter for disposal and a solids deficient stream 105. The solids deficient stream 105 can be fed through heat exchanger 25, using heating fluid supply 129 to pretreat solids deficient stream 105 before being fed to the first iron mixer 40. An iron catalyst stream 119, which can comprise zero-valent iron, and the solids deficient stream can be mixed in the first iron mixer 40, producing a first catalyzed stream 111. The first catalyzed stream 111 can be fed to the microwave system 50, producing microwaved stream 113. The microwaved stream 113 can be fed through an iron separator 60, producing an iron depleted stream 115, and a zero-valent iron stream 155, which can be disposed or reused. Iron depleted stream 115 can be fed to a second iron catalyst mixer 80.

An iron salt stream 109 comprising Fe(II)SO₄ can be mixed with the iron depleted stream 115 using a second iron catalyst mixer 80, producing a second catalyzed stream 123 before being fed to the ultraviolet system 70.

Hydrogen peroxide stream 127 can be preferably sprayed or atomized directly onto the second catalyzed stream 123 within the ultraviolet system 70 while both the hydrogen peroxide stream 127 and the second catalyzed stream 123 are simultaneously exposed to the ultraviolet light.

The irradiated stream 122 can be fed to an aerator 300, which can use ambient air, represented by stream 114 for further oxidation; producing an aerated stream 133 and precipitated solids 117, which can be fed to a degasifier 310, producing precipitated solids 117, an offgas 163 and a degassed stream 149 for recycling or storing as treated stream 135. Treated stream 135 can also be reused or disposed. Preferably, gravity flow integral aerators/degasifiers such as cascade aerators or units made of witches' hats can be used for aeration and degasification.

Settling tanks (not shown) can be used to concentrate collected precipitated solids streams 117 for disposal from the aerator 300 and degasifier 310. Optionally, as seen in FIG. 5b, the aerated stream 133 can be fed to a degasifier 310, producing a precipitated solids stream 117, an offgas 163 and a degassed stream 149, which can be fed to desalinator 320 for removal of salts, producing a treated stream 135 and a brine 57. The treated stream 135 can flow to treated wastewater tank 200 or preferably, the treated stream 135 can be recycled. The treated stream 135 can be recycled before or after storage in treated wastewater tank 200. The treated stream 135 can also be reused or disposed.

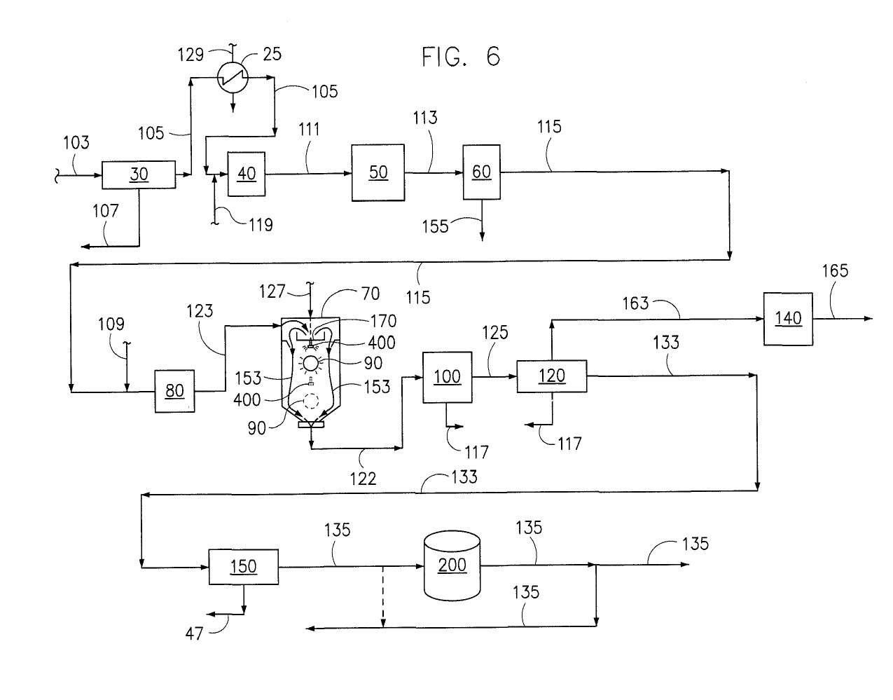

Referring to FIG. 6 the waste stream 103 can be fed to a fine solids removal system 30, producing a fine solids steam 107 and a solids depleted stream 105. The fine solids removal system 30 can be configured for different particle size removal ranging from particles greater than 30 microns, preferably 20 microns or more preferably 10 microns. The solids deficient stream 105 can be fed through heat exchanger 25 before being mixed with iron catalyst stream 119, comprising zero-valent iron, and fed to the first iron mixer 40 producing a first catalyzed stream 111. Heat exchanger 25 can use heating fluid supply 129 for preheating solids deficient stream 105. The first catalyzed stream 111 can be fed to the microwave system 50, producing microwaved stream 113. The microwaved stream 113 can be fed through an iron separator 60, producing an iron depleted stream 115 and a zero-valent iron stream 155. The zero-valent iron stream 155 can be disposed or reused. The iron depleted stream 115 can be fed to a second iron catalyst mixer 80.

An iron salt stream 109 comprising Fe(II)SO₄ can be mixed with the iron depleted stream 115 using a second iron catalyst mixer 80, producing a second catalyzed stream 123 for feeding to the ultraviolet system 70 to further promote oxidation by Fenton's Reaction. The second catalyzed stream 123 can be channeled into at least one sheet of fluid 153 by distributer 170.

Hydrogen peroxide stream 127 can be preferably sprayed or atomized directly onto the at least one sheet of fluid 153 using nozzle 400 within the ultraviolet system 70. Both the hydrogen peroxide steam 127 and the at least one sheet of fluid 153 can be simultaneously and separately exposed to the ultraviolet light. Nozzle 400 can be located above, below or at the side of ultraviolet source 90 within the ultraviolet system 70. The ultraviolet system 70 can comprise more than one ultraviolet source 90 and nozzle 400. Nozzles 400 can be configured to provide conical, flat or solid spray patterns. Nozzle 400 spray patterns, ultraviolet source 90 locations and distributor 170 configurations can be designed to vary the length of time the hydrogen peroxide stream 127 is separately exposed to ultraviolet light before impinging the at least one sheet of fluid 153 and the distance between the hydrogen peroxide spray is from the ultraviolet source.

The irradiated stream 122 can be fed to a hydroxyl mixer 100, producing a precipitated solids stream 117 and a reacted stream 125 and offgas 163. The irradiated stream 122 can be directly fed to integral aerators/degasifers, which can be used as the hydroxyl mixer 100 or flow into a holding tank (not shown) and pumped to the hydroxyl mixer 100. The hydroxyl mixer may be a series of hollow cones, commonly known as witches' hats, for further oxidation. Settling tanks (not shown) can be used to collect precipitated solids streams for disposal. The reacted stream 125 can be fed to at least one sparger 120, producing precipitated solids stream 117, an aerated stream 133 and offgas 163.

The aerated stream 133 can be fed to a liquid membrane 150, commercially available, for filtering. Preferably, the liquid membrane 150 can be a cross flow configuration using a porous synthetic membrane. The liquid membrane 150 can produce a stripped solids and salts stream 47 and a treated stream 135 which can flow to treated wastewater tank 200 or preferably, recycled. The treated stream 135 can be recycled before or after storage. The treated stream 135 can also be reused or disposed.

The offgas 163 can be fed to a gas membrane 140, producing an exhaust gas 165. The gas membrane 140 can be a porous synthetic membrane or preferably a dense synthetic membrane.

It must also be understood that the structural details of the described embodiments of apparatus (such as the microwave system 50 and ultraviolet system 70) can be modified and their arrangements (vertical or horizontal positioning) can be changed.

What is claimed is:

1. A fluid utilized as a hydrocarbon-servicing fluid, which is exposed to microwaves and ultraviolet light.

2. The fluid of claim 1 wherein the fluid is selected from the group consisting of acidizing fluid, cleaning fluid, produced fluid, drilling fluid, frac fluid, injection fluid or a combination thereof.

3. The fluid of claim 1 wherein the fluid comprises flowback water.

4. The fluid of claim 1 wherein the fluid comprises cooling tower water.

5. A method for treating a hydrocarbon-servicing fluid comprising:
microwaving the hydrocarbon-servicing fluid;
irradiating the hydrocarbon-servicing fluid with ultraviolet light; and
producing a treated stream.

6. The method of claim 5 further comprising pumping at least a portion of the treated stream into a wellbore.

7. The method of claim 5 further comprising using at least a portion of the treated stream to fracture a formation.

8. The method of claim 5 further comprising the steps of storing the treated stream and recycling at least a portion of the treated stream into a wellbore before or after storing the treated stream.

9. A method for treating a hydrocarbon-servicing fluid comprising the steps of:
mixing an iron catalyst stream with the hydrocarbon-servicing fluid, producing a first catalyzed stream; and
microwaving the first catalyzed stream, producing a microwaved stream.

10. The method of claim 9 wherein the microwaving step is substantially at least 0.3 seconds.

11. The method of claim 9 wherein the microwaving step utilizes frequencies from about 2.4 GHz to about 5.8 GHz.

12. The method of claim 9 further comprising the step of heating the first catalyzed stream substantially at least 120° F.

13. The method of claim 9 wherein the iron catalyst stream comprises zero-valent iron and further comprising the step of separating a substantial portion of the zero-valent iron from the microwaved stream.

14. A method for treating a waste stream comprising the steps of:
separating the waste stream into an oily water stream, a large solids stream and a pretreated stream;
removing solids substantially at least 10 microns from the pretreated stream, producing a fine solids stream and a solids deficient stream;
mixing an iron catalyst stream with the solids deficient stream, producing a first catalyzed stream;
microwaving the first catalyzed stream, producing a microwaved stream;
providing an iron salt stream;
mixing the iron salt stream with the microwaved stream, providing a second catalyzed stream;
providing a hydrogen peroxide stream;
irradiating the hydrogen peroxide stream and the second catalyzed stream with ultraviolet light simultaneously, producing an irradiated stream.

15. A method for treating a waste stream comprising the steps of:
separating the waste stream into an oily water stream, a large solids stream and a pretreated stream;
removing solids substantially at least 10 microns from the pretreated stream, producing a fine solids stream and a solids deficient stream;
mixing an iron catalyst stream comprising zero-valent iron with the solids deficient stream, producing a first catalyzed stream;
microwaving the first catalyzed stream, producing a microwaved stream;
separating at least a substantial portion of the zero-valent iron from the microwaved stream; and
producing an iron depleted stream.

16. The method of claim 15 wherein the waste stream is pit sludge, or tank sludge.

17. The method of claim 15 further comprising the step of heating the first catalyzed stream from about 120° F. to about 140° F.

18. The method of claim 15 further comprising the step of heating the first catalyzed stream to substantially at least 120° F. or greater.

19. The method of claim 18 further comprising the step of irradiating the iron depleted stream with ultraviolet light, producing an irradiated stream.

20. The method of claim 19 further comprising the steps of:
providing a hydrogen peroxide stream; and
irradiating the hydrogen peroxide stream and the iron depleted stream with ultraviolet light simultaneously.

21. The method of claim 20 further comprising the steps of:
providing an iron salt stream; and
mixing the iron salt stream with the iron depleted stream.

22. The method of claim 21 further comprising the steps of:
aerating the irradiated stream, producing an aerated stream; and
degassing the aerated stream, producing a degassed stream.

23. The method of claim 22 further comprising the step of removing a portion of salt from the degassed stream, producing a treated stream.

24. The method of claim 23 further comprising the steps of storing the treated stream in a treated wastewater tank and recycling a portion of the treated stream into a wellbore before or after storing the treated stream.

25. A method for treating a waste stream comprising the steps of:
providing the waste stream to a fine solids removal system;
removing fine solids being substantially at least 10 microns from the waste stream, producing a solids deficient stream;
mixing an iron catalyst stream comprising zero-valent iron with the solids deficient stream, producing a first catalyzed stream;
microwaving the first catalyzed stream, producing a microwaved stream;
separating a substantial portion of the zero-valent iron from the microwaved stream, producing a zero-valent iron stream and an iron depleted stream;
mixing an iron salt stream with the iron depleted stream, producing a second catalyzed stream;
channeling the second catalyzed stream in an ultraviolet system, producing at least one fluid sheet;
providing a hydrogen peroxide stream to the ultraviolet system;
irradiating the hydrogen peroxide stream and the at least one fluid sheet with ultraviolet light simultaneously, producing an irradiated stream;
oxygenating the irradiated stream, producing an aerated stream, off gas and a precipitated solids stream; and
filtering the aerated stream, producing a treated stream.

26. The method of claim 25 further comprising the step of heating the solids deficient stream to substantially at least 120° F. or greater.

27. The method of claim 25 wherein providing the hydrogen peroxide stream to the ultraviolet system further comprises the step of creating a hydrogen peroxide spray from a nozzle within the ultraviolet system such that a substantial portion of the hydrogen peroxide spray is less than substantially 5 centimeters from an ultraviolet source within the ultraviolet system.

28. The method of claim 25 wherein the irradiating step further comprises irradiating the hydrogen peroxide stream and the at least one fluid sheet separately with ultraviolet light.

29. The method of claim 25 wherein the waste stream is flowback water.

30. The method of claim 25 wherein the waste stream is a produced fluid.

31. The method of claim 25 wherein the waste stream is a geothermal produced fluid.

32. The method of claim 25 wherein the waste stream is a drilling fluid.

33. The method of claim 25 wherein the waste stream is a tank sludge or pit sludge.

34. The method of claim 25 wherein the waste stream is a downstream operation wastewater treatment effluent.

35. The method of claim 25 wherein the waste stream is cooling water.

36. The method of claim 25 wherein the oxygenating step utilizes witches' hats.

37. The method of claim 25 wherein the oxygenating step utilizes at least one sparger.

38. The method of claim 36 further comprising the steps of:
filtering the off gas with a gas membrane;
producing an exhaust gas; and
filtering the precipitated solids stream with a liquid membrane, producing a stripped solids and salts stream and a treated stream.
